(19) United States
(12) Patent Application Publication
(10) Pub. No.: US 2012/0181355 A1
(43) Pub. Date: Jul. 19, 2012

(54) SYSTEM FOR FLOW CONTROL IN FUEL INJECTORS

(75) Inventors: Judeth Brannon Corry, Manvel, TX (US); Paul Stephen Dimascio, Greer, SC (US); Douglas S. Byrd, Greer, SC (US)

(73) Assignee: General Electric Company, Schenectady, NY (US)

(21) Appl. No.: 13/007,945

(22) Filed: Jan. 17, 2011

(51) Int. Cl. F16K 21/00

(52) U.S. Cl. 239/436

(57) ABSTRACT

A system includes a gasification fuel injector. The gasification fuel injector includes a body having a tip portion, a first conduit extending through the body toward the tip portion, a second conduit extending through the body toward the tip portion, and a flow control device disposed in the first conduit upstream of the tip portion. The flow control device is configured to limit a first flow through the first conduit.

### BACKGROUND OF THE INVENTION

The subject matter disclosed herein relates to fuel injectors, and, more particularly, to flow control in fuel injectors.

A variety of combustion systems employ fuel injectors to inject a fuel into a combustion chamber. For example, an integrated gasification combined cycle (IGCC) power plant includes a gasifier with one or more fuel injectors. The fuel injectors supply a fuel, such as an organic feedstock, into the gasifier along with oxygen and steam to generate a syngas. The fuel injectors may include one or more conduits for the fuel, oxygen, and/or steam. In addition, control valves may be located upstream from the fuel injectors to control flow rates of the fuel, oxygen, and/or steam. The control valves may enable a user to vary flow rates of each of the streams passing through the conduits independently. However, the independent control of the flow rates may cause poor performance of the fuel injectors. For example, the user may open the control valve for the oxygen in one conduit without appropriately adjusting the flow in another conduit, thereby resulting in undesirable fuel injector performance. Unfortunately, existing external control techniques are unable to prevent all undesirable positioning of the control valves to the fuel injectors, thereby decreasing performance of the fuel injectors.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gasification fuel injector. The gasification fuel injector includes a body having a tip portion, a first conduit extending through the body toward the tip portion, a second conduit extending through the body toward the tip portion, and a flow control device disposed in the first conduit upstream of the tip portion. The flow control device is configured to limit a first flow through the first conduit.

In a second embodiment, a system includes a fuel injector. The fuel injector includes a body having a tip portion, a first conduit extending through the body toward the tip portion, and a removable insert disposed in the first conduit. The removable insert comprises a flow control feature to limit flow through the first conduit to a range.

In a third embodiment, a system includes a fuel injector. The fuel injector includes a first conduit configured to inject a first fluid and a second conduit configured to inject a second fluid different from the first fluid. The first and second conduits are coaxial with one another. The fuel injector also includes a flow control device disposed in the first conduit. The flow control device comprises a constriction.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an IGCC power plant incorporating a fuel injector according to an embodiment;

FIG. 2 is an axial cross-section of an embodiment of a fuel injector with a venturi section;

FIG. 3 is a radial cross-section of an embodiment of a fuel injector with a venturi section;

FIG. 4 is an axial cross-section of an embodiment of a fuel injector with a restriction orifice; and

FIG. 5 is an exploded schematic of various embodiments of flow control devices that may be removably coupled to one or more conduits of a fuel injector.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments incorporate a flow control device, such as a restriction orifice or a venturi section, in one or more fluid passages of a fuel injector. The flow control device is configured to regulate or limit flow through the fluid passage, thereby ensuring flow within a range to maintain performance despite changes in valve positions. The term “fluids” may include liquids, gases, liquids or gases carrying solids, or any combination thereof. For example, the fluids may include fuel (e.g., gas, liquid, or slurry), air, oxygen, carbon dioxide (CO₂), nitrogen, steam, or any combination thereof. By further example, an IGCC power plant may have a gasifier that includes one or more gasification fuel injectors. Each of the gasification fuel injectors may include one or more conduits, or passageways, configured to inject the fuel and other fluids. External control valves may be used to control flow rates of the fuel and other fluids to the fuel injectors. Thus, a user may be able to vary the flow rates of the fuel and other fluids independently. For example, the user may increase the flow rate of the fuel without appropriately adjusting the flow rates of the other fluids. In addition, control valves may be incorrectly sized or may pass different flow rates with time, because of wear or damage. However, the fuel injector may be configured to operate most efficiently within particular ranges of the fuel to the other fluids. Therefore, each flow control device is configured to regulate or limit the flow through a particular passage, such that the range of efficient operation is achieved despite user error, wear, or damage associated with the valves.

In various embodiments described below, a gasification fuel injector includes a flow control device in a conduit of the fuel injector upstream of a tip portion of the fuel injector. The flow control device may be configured to limit a flow through the conduit via a restriction orifice or venturi section. The flow control device may be specifically tailored to a fluid type, valves, combustion system, and so forth. Furthermore, the flow control device may be selected from a plurality of flow control devices, each having different flow control characteristics. For example, each flow control device may limit the flow rate to a different range regardless of the position of the control valve for the fluid. Thus, the performance of the fuel injector may be maintained despite incorrect positions of the control valves. In addition, the flow control device may be a removable insert. Thus, a plurality of removable flow control devices may be selectively installed and removed from the fuel injector depending on the particular requirements of an application. The following discussion presents the flow control devices in context of an IGCC system as on exemplary application, yet the disclosed flow control devices may be used in any fuel injector.

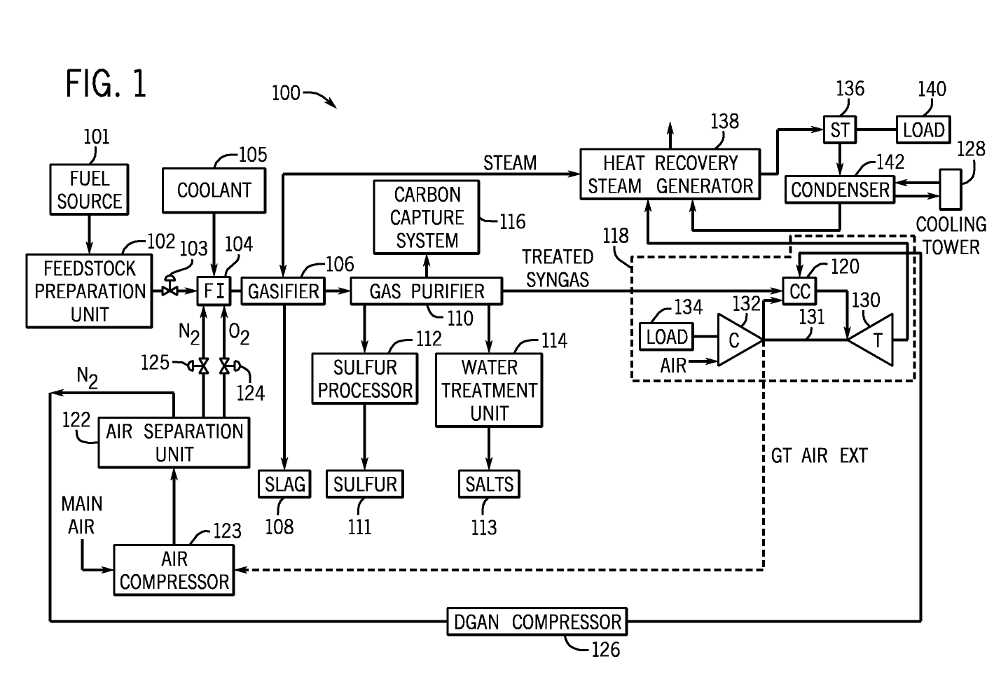

Turning now to the drawings, FIG. 1 is a diagram of an embodiment of an IGCC system 100 that may produce and burn a synthetic gas, i.e., syngas. As discussed in detail below, the IGCC system 100 may include an embodiment of a gasification fuel injector that includes a flow control device disposed in at least one conduit and configured to limit a flow through the conduit. Other elements of the IGCC system 100 may include a fuel source 101, which may be a solid or a liquid, that may be utilized as a source of energy for the IGCC system. The fuel source 101 may include coal, petroleum coke, oil, biomass, wood-based materials, agricultural wastes, tars, coke oven gas and asphalt, or other carbon containing items.

The fuel of the fuel source 101 may be passed to a feedstock preparation unit 102. The feedstock preparation unit 102 may, for example, resize or reshape the fuel source 101 by chopping, milling, shredding, pulverizing, briquetting, or palletizing the fuel source 101 to generate feedstock. Additionally, water, or other suitable liquids may be added to the fuel source 101 in the feedstock preparation unit 102 to create slurry feedstock. In other embodiments, no liquid is added to the fuel source, thus yielding dry feedstock. In some embodiments, the feedstock preparation unit 102 may be omitted if the fuel source 101 is a liquid. In certain embodiments, the fuel source 101 may be a gas, such as natural gas.

Next, the feedstock may be passed through a feedstock control valve 103 before passing to a fuel injector 104 coupled to a gasifier 106. The control valve 103 may receive signals from a control system to manipulate the flow rate of the fuel source 101 through the control valve 130. In addition, a coolant 105 (e.g., water) may be directed to the fuel injector 104 to provide cooling and extend the life of the fuel injector 104. As appreciated, the gasifier 106 is one example of a combustion chamber that may use the fuel injector 104, which includes the flow control device as discussed in detail below. In certain embodiments, the fuel injector 104 combines the various feed streams to the gasifier 106 in such a manner as to promote efficient combustion. Specifically, the gasifier 106 may convert the feedstock into a syngas, e.g., a combination of carbon monoxide and hydrogen. This conversion may be accomplished by subjecting the feedstock to a controlled amount of steam and oxygen at elevated pressures, e.g., from approximately 20 bar to 85 bar, and temperatures, e.g., approximately 700 degrees C. to 1600 degrees C., depending on the type of gasifier 106 utilized. The gasification process may include the feedstock undergoing a pyrolysis process, whereby the feedstock is heated. Temperatures inside the gasifier 106 may range from approximately 150 degrees C. to 700 degrees C. during the pyrolysis process, depending on the fuel source 101 utilized to generate the feedstock. The heating of the feedstock during the pyrolysis process may generate a solid (e.g., char) and residue gases (e.g., carbon monoxide, hydrogen, and nitrogen). The char remaining from the feedstock from the pyrolysis process may only weigh up to approximately 30% of the weight of the original feedstock.

A combustion process may then occur in the gasifier 106. The combustion may include introducing oxygen to the char and residue gases. The char and residue gases may react with the oxygen to form CO₂ and carbon monoxide, which provides heat for the subsequent gasification reactions. The temperatures during the combustion process may range from approximately 700 degrees C. to 1600 degrees C. Next, steam may be introduced into the gasifier 106 during a gasification step. The char may react with the CO₂ and steam to produce carbon monoxide and hydrogen at temperatures ranging from approximately 800 degrees C. to 1100 degrees C. In essence, the gasifier utilizes steam and oxygen to allow some of the feedstock to be “burned” to produce carbon monoxide and release energy, which drives a second reaction that converts further feedstock to hydrogen and additional CO₂.

In this way, the gasifier 106 manufactures a resultant gas. This resultant gas may include approximately 85% of carbon monoxide and hydrogen in equal proportions, as well as CH₄, HCl, HF, COS, NH₃, HCN, and H₂S (based on the sulfur content of the feedstock). This resultant gas may be termed untreated syngas, because it includes, for example, H₂S. The gasifier 106 may also generate waste, such as slag 108, which may be a wet ash material. This slag 108 may be removed from the gasifier 106 and disposed of, for example, as road base or as another building material. To clean the untreated syngas, a gas purifier 110 may be utilized. In one embodiment, the gas purifier 110 may be a water gas shift reactor. The gas purifier 110 may scrub the untreated syngas to remove the HCl, HF, COS, HCN, and H₂S from the untreated syngas, which may include separation of sulfur 111 in a sulfur processor 112 by, for example, an acid gas removal process in the sulfur processor 112. Furthermore, the gas purifier 110 may separate salts 113 from the untreated syngas via a water treatment unit 114 that may utilize water purification techniques to generate usable salts 113 from the untreated syngas. Subsequently, the gas from the gas purifier 110 may include treated syngas (e.g., the sulfur 111 has been removed from the syngas), with trace amounts of other chemicals, e.g., NH₃ (ammonia) and CH₄ (methane).

In some embodiments, a gas processor may be utilized to remove additional residual gas components, such as ammonia and methane, as well as methanol or any residual chemicals from the treated syngas. However, removal of residual gas components from the treated syngas is optional, because the treated syngas may be utilized as a fuel even when it includes the residual gas components, e.g., tail gas. At this point, the treated syngas may include approximately 3% CO, approximately 55% H₂, and approximately 40% CO₂ and is substantially stripped of H₂S.

In some embodiments, a carbon capture system 116 may remove and process the carbonaceous gas (e.g., CO₂ that is approximately 80-100 or 90-100 percent pure by volume) included in the syngas. The carbon capture system 116 also may include a compressor, a purifier, a pipeline that supplies CO₂ for sequestration or enhanced oil recovery, a CO₂ storage tank, or any combination thereof. The captured CO₂ may be transferred to a CO₂ expander, which decreases the temperature of the CO₂ (e.g., approximately 5-100 degrees C., or about 20-30 degrees C.), thus enabling the CO₂ to be used as a suitable cooling agent for the system. The cooled CO₂ (e.g., approximately 20-40 degrees C., or about 30 degrees C.) may be circulated through the system to meet its refrigeration needs or expanded through subsequent stages for even lower temperatures. Carbon dioxide may also be used as the coolant 105 for the fuel injector 104. The treated syngas, which has undergone the removal of its sulfur containing components and a large fraction of its CO₂, may be then transmitted to a combustor 120, e.g., a combustion chamber, of a gas turbine engine 118 as combustible fuel.

The IGCC system 100 may further include an air separation unit (ASU) 122. The ASU 122 may operate to separate air into component gases by, for example, distillation techniques. The ASU 122 may separate oxygen from the air supplied to it from a supplemental air compressor 123, and the ASU 122 may transfer the separated oxygen to the fuel injector 104 after passing through an oxygen control valve 124. Additionally, the ASU 122 may transmit separated nitrogen to the fuel injector 104 (e.g., as coolant 105) after passing through nitrogen control valve 125 or a diluent nitrogen (DGAN) compressor 126. The oxygen and nitrogen control valves 124 and 125 may receive signals from the control system to manipulate the flow rates of the oxygen and nitrogen to the fuel injector 104.

The DGAN compressor 126 may compress the nitrogen received from the ASU 122 at least to pressure levels equal to those in the combustor 120, so as not to interfere with the proper combustion of the syngas. Thus, once the DGAN compressor 126 has adequately compressed the nitrogen to a proper level, the DGAN compressor 126 may transmit the compressed nitrogen to the combustor 120 of the gas turbine engine 118. The nitrogen may be used as a diluent to facilitate control of emissions, for example.

As described previously, the compressed nitrogen may be transmitted from the DGAN compressor 126 to the combustor 120 of the gas turbine engine 118. The gas turbine engine 118 may include a turbine 130, a drive shaft 131, and a compressor 132, as well as the combustor 120. The combustor 120 may receive fuel, such as syngas, which may be injected under pressure from fuel nozzles. This fuel may be mixed with compressed air as well as compressed nitrogen from the DGAN compressor 126, and combusted within combustor 120. This combustion may create hot pressurized exhaust gases.

The combustor 120 may direct the exhaust gases towards an exhaust outlet of the turbine 130. As the exhaust gases from the combustor 120 pass through the turbine 130, the exhaust gases force turbine blades in the turbine 130 to rotate the drive shaft 131 along an axis of the gas turbine engine 118. As illustrated, the drive shaft 131 is connected to various components of the gas turbine engine 118, including the compressor 132.

The drive shaft 131 may connect the turbine 130 to the compressor 132 to form a rotor. The compressor 132 may include blades coupled to the drive shaft 131. Thus, rotation of turbine blades in the turbine 130 may cause the drive shaft 131 connecting the turbine 130 to the compressor 132 to rotate blades within the compressor 132. This rotation of blades in the compressor 132 causes the compressor 132 to compress air received via an air intake in the compressor 132. The compressed air may then be fed to the combustor 120 and mixed with fuel and compressed nitrogen to allow for higher efficiency combustion. The drive shaft 131 may also be connected to load 134, which may be a stationary load, such as an electrical generator for producing electrical power, for example, in a power plant. Indeed, load 134 may be any suitable device that is powered by the rotational output of the gas turbine engine 118.

The IGCC system 100 also may include a steam turbine engine 136 and a heat recovery steam generation (HRSG) system 138. The steam turbine engine 136 may drive a second load 140. The second load 140 may also be an electrical generator for generating electrical power. However, both the first 134 and second 140 loads may be other types of loads capable of being driven by the gas turbine engine 118 and steam turbine engine 136. In addition, although the gas turbine engine 118 and steam turbine engine 136 may drive separate loads 134 and 140, as shown in the illustrated embodiment, the gas turbine engine 118 and steam turbine engine 136 may also be utilized in tandem to drive a single load via a single shaft. The specific configuration of the steam turbine engine 136, as well as the gas turbine engine 118, may be implementation-specific and may include any combination of sections.

The system 100 may also include the HRSG 138. Heated exhaust gas from the gas turbine engine 118 may be transported into the HRSG 138 and used to heat water and produce steam used to power the steam turbine engine 136. Exhaust from, for example, a low-pressure section of the steam turbine engine 136 may be directed into a condenser 142. The condenser 142 may utilize a cooling tower 128 to exchange heated water for chilled water. The cooling tower 128 acts to provide cool water to the condenser 142 to aid in condensing the steam transmitted to the condenser 142 from the steam turbine engine 136. Water from the cooling tower 128 may also be used as coolant 105 for the fuel injector 104. Condensate from the condenser 142 may, in turn, be directed into the HRSG 138. Again, exhaust from the gas turbine engine 118 may also be directed into the HRSG 138 to heat the water from the condenser 142 and produce steam.

In combined cycle systems, such as the IGCC system 100, hot exhaust may flow from the gas turbine engine 118 and pass to the HRSG 138, where it may be used to generate high-pressure, high-temperature steam. The steam produced by the HRSG 138 may then be passed through the steam turbine engine 136 for power generation. In addition, the produced steam may also be supplied to any other processes where steam may be used, such as to the gasifier 106 or to the fuel injector 104 as coolant 105. The gas turbine engine 118 generation cycle is often referred to as the “topping cycle,” whereas the steam turbine engine 136 generation cycle is often referred to as the “bottoming cycle.” By combining these two cycles as illustrated in FIG. 1, the IGCC system 100 may lead to greater efficiencies in both cycles. In particular, exhaust heat from the topping cycle may be captured and used to generate steam for use in the bottoming cycle.

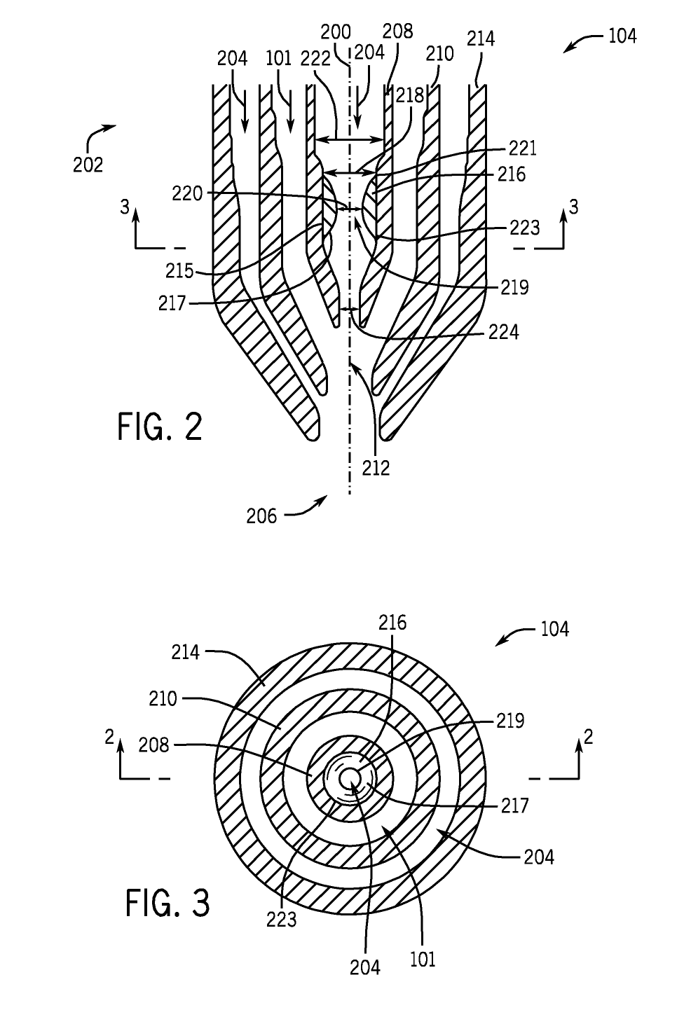

Turning next to the fuel injector 104 in more detail, FIG. 2 is an axial cross-section of the fuel injector 104 in accordance with an embodiment. An axial axis 200 passes through the center of the fuel injector 104. The fuel injector 104 has an upstream side 202, from which the fuel 101 and oxygen 204 may originate. The oxygen 204 may include oxygen, air, other oxidants, or any combination thereof. In other embodiments, the fuel injector 104 may be configured to inject other fluids, such as, but not limited to, CO₂, air, nitrogen, steam, or any combination thereof. The body of the fuel injector 104 also has a tip portion 206, where the fuel 101 and oxygen 204 exits. Thus, the tip 206 is an outlet for the materials. Turning next to the conduits of the fuel injector 104, the conduits extend through the body of the fuel injector 104 toward the tip 206. In addition, although one arrangement of conduits will be described, other arrangements are possible depending on the requirements of a particular application. Specifically, the innermost material passing through the fuel injector 104 is the oxygen 204, which is directed to the tip 206 by a first conduit 208. The first conduit 208 supplies oxygen 204 for partial oxidation.

The next outermost material is the fuel 101, which is directed to the tip 206 by a second conduit 210. Thus, the second conduit 210 surrounds the first conduit 208 in a coaxial or concentric arrangement. The fuel 101 may include a dry fuel, a slurry fuel, a liquid fuel, or any combination thereof. The second conduit 210 directs the fuel 101 just downstream of the oxygen 204 from the first conduit 208 to enhance the mixing of the fuel 101 and the oxygen 204. The region where the oxygen 204 from the first conduit 208 and the fuel 101 combine is referred to as a pre-mix zone 212. Some embodiments may omit the pre-mix zone 212. The next outermost material is the oxygen 204, which is directed to the tip 206 of the fuel injector 104 by a third conduit 214. Thus, the third conduit 214 surrounds the second conduit 210 in a coaxial or concentric arrangement. The third conduit 214 may direct the oxygen 204 to the mixture of the fuel 101 and the oxygen 204 from the first conduit 208 to produce a fine spray for efficient partial oxidation. The oxygen 204 may also include a diluent, such as nitrogen. In certain embodiments, the oxygen 204 to the first conduit 208 and the oxygen 204 to the third conduit 214 may be independently controlled, such as by two separate oxygen control valves 124, for example.

As shown in FIG. 2, a flow control device 216, or flow control feature, may be disposed in the first conduit 208. In FIG. 2, the flow control device 216 is configured as a venturi section. The venturi section 216 may include a hollow right circular cylinder 215 (e.g., cylindrical exterior) with an hourglass-shaped interior 217 (e.g., a converging-diverging passage). Specifically, an outer diameter 218 of the venturi section 216 is greater than an inner diameter 220 of the venturi section 216. For example, a ratio of the outer diameter 218 to the inner diameter 220 at a throat 219 may be between approximately 100:1 to 1.5:1, 50:1 to 3:1, or 25:1 to 10:1. Moreover, the inner diameter 220 of the venturi section 216 gradually decreases along an upstream converging portion 221 to the throat 219, and gradually increases from the throat 219 along a downstream diverging portion 223 in a direction of flow toward the tip 206. In some embodiments, the inner diameter 220 of the venturi section 216 may change in a linear or non-linear manner, e.g., a straight taper or a curved taper. Furthermore, the slope of the upstream converging portion 221 and the downstream diverging portion 223 may be increased or decreased in various embodiments. The various configurations of the venturi section 216 limit the flow rate of the oxygen 204, or other fluids, such as, but not limited to, CO₂, air, nitrogen, steam, or any combination thereof, through the first conduit 208. In certain embodiments, a choked flow of the oxygen 204 through the venturi section 216 may occur, in which a velocity of the oxygen 204 approaches the local speed of sound. During choked flow, a mass flow rate of the oxygen 204 will not increase with a further decrease in a downstream pressure. By limiting the flow rate of the oxygen 204 through the fuel injector 104, the venturi section 216 may help the fuel injector 104 to operate within a desirable range regardless of the position of the oxygen control valve 124 or the fuel control valve 103. For example, even if the oxygen control valve 124 was in a full-open position, the venturi section 216 may limit the flow rate of the oxygen 204 to a range, such as choked flow, for example.

The flow control device (e.g., venturi section) 216 may be a removable insert or integrated (e.g., one-piece) with the first conduit 208. In the illustrated embodiment, the venturi section 216 is configured as a removable insert. Thus, methods for securing the venturi section 216 in the fuel injector 104 may be selected to enable the venturi section 216 to be removable. For example, the exterior 215 of the venturi section 216 may be threaded and configured to engage with threads disposed on the inner surface of the first conduit 208. Such a removable configuration of the venturi section 216 may enable different flow control devices 216 (e.g., venturi sections or restriction orifices) capable of limiting flow rates to different values to be installed in the fuel injector 104. For example, the gasifier 106 may be modified to operate at higher flow rates. Without replacing the fuel injector 104, a different removable flow control device 216 (e.g., venturi section or restriction orifice) configured to limit the flow rate of oxygen 204 or fuel 101 to a higher value may be installed in the fuel injector 104 to replace the existing venturi section 216. Conversely, if the gasifier 106 is modified to operate at lower flow rates, then a different removable flow control device 216 (e.g., venturi section or restriction orifice) configured to limit flow to a lower flow rate may be installed in the fuel injector 104 to replace the existing venturi section 216. Thus, one of several removable flow control devices 216 (e.g., venturi sections or restriction orifices) may be selected for installation in the fuel injector 104 depending on the requirements of a particular application. In other words, each removable flow control device 216 is selectively swappable with one or more removable flow control devices 216. Each of the one or more removable flow control devices 216 may differ in terms of flow control range, flow control structure, or flow passage geometry. Examples of different flow control devices 216 that may be selectively swappable with one or more removable flow control devices 216 are discussed in detail below.

In certain embodiments, an upstream diameter 222 of the first conduit 208 may be greater than the outer diameter 218 of the venturi section 216 to help facilitate installation of the venturi section 216. In other words, the venturi section 216 may be installed into the fuel injector 104 from the upstream side 202. In other embodiments, the upstream diameter 222 may be approximately the same as the outer diameter 218. Further, a downstream diameter 224 of the first conduit 208 may be less than the outer diameter 218 of the venturi section 216 to help the venturi section 216 to remain in the first conduit 208 during operation. Specifically, the venturi section 216 is disposed in the first conduit 208 upstream of the tip 206. Such a location near the tip 206 may enable the venturi section 216 to better control flow rates than other devices, such as control valves, disposed further away (i.e., upstream) from the tip 206. In other embodiments, the downstream diameter 224 may be approximately the same as the outer diameter 218 or greater than the outer diameter 218. To accommodate these different configurations, a variety of fasteners or mounts may be used to secure the venturi section 216 in the first conduit 208 including, but not limited to, threaded connections, interference fits, threaded fasteners (e.g., screws or bolts), lock pins, adhesives, or any combination thereof.

In addition, the venturi section 216 may be made from materials similar to those used for the other components of the fuel injector 104. For example, the venturi section 216 may be made from metals, ceramics, cermets, or any combination thereof. In particular embodiments, the interior 217 of the venturi section 216 exposed to the oxygen 204 may include a protective coating, which may be made from a second material that is harder and/or more durable than a first material used for the rest of the venturi section 216. For example, the protective coating may be made from tungsten carbide, while the remainder of the venturi section 216 may be made of steel. Such a configuration of the venturi section 216 may help to reduce erosion of the interior 217 of the venturi section 216, thereby extending the life of the venturi section 216.

As discussed in detail below, installation of the venturi section 216 is not limited to only the first conduit 208. Flow control devices 216 may be used in any one or more (e.g., one, two, or all three) of the conduits of the fuel injector 104. For example, an embodiment of the venturi section 216 may be disposed in the second conduit 210, the third conduit 214, or any other conduits of the fuel injector 104. For example, the venturi section 216 may also be used to limit the flow rate of the fuel 101 through the second conduit 210 or the flow rate of the oxygen 204 through the third conduit 214. In addition, the fuel injector 104 may include more than one venturi section 216 at a time to limit flow rates of more than one fluid flowing through conduits of the fuel injector 104. For example, venturi sections 216 may be disposed in conduits of the fuel injector 104 to limit flow rates of gases, such as, but not limited to, oxygen 204, CO₂, air, nitrogen, steam, or any combination thereof. In addition, conduits of the fuel injector 104 may include venturi sections to limit flow rates of any type of fuel 101, such as, but not limited to, a dry fuel, a slurry fuel, a liquid fuel, or any combination thereof.

In certain embodiments, one or more venturi sections 216 may be disposed in the fuel injector 104 to control a flow split and/or a ratio of fluid flows through the fuel injector 104. In one embodiment, a venturi section 216 may be disposed in the first conduit 208 or the third conduit 214 to control a flow split of oxygen 204 between the conduits 208 and 214. For example, a first venturi section 216 may be disposed in the first conduit 208 and a second venturi section 216 may be disposed in the third conduit 214. The two venturi sections 216 may be configured to achieve a desired split of the flow rates of oxygen 204 flowing through the first and third conduits 208 and 214. For example, the one or two venturi sections 216 may be configured such that the flow rate of oxygen 204 in the first conduit 208 is greater than the flow rate of oxygen in the third conduit 214, or vice versa. In another embodiment, a venturi section 216 may be disposed in the second conduit 210 (fuel 101) or the first and/or third conduits 208 and 214 (oxygen 204) to control a fuel/oxygen ratio. For example, a first venturi section 216 may be disposed in the first conduit 208 and a second venturi section 216 may be disposed in the second conduit 210. Thus, the two venturi sections 216 may be configured to help achieve a desired split, or ratio, of the flow rates of oxygen 204 and fuel 101. For example, the venturi sections 216 may be configured such that the flow rate of oxygen 204 in the first conduit 208 is greater than the flow rate of fuel 101 in the second conduit 210, or vice versa. In other words, use of more than one venturi section 216 in the fuel injector 104 may help to achieve a desired ratio of flows between the one or more conduits of the fuel injector 104.

FIG. 3 is a radial cross-section of the fuel injector 104 along line 3-3 of FIG. 2, illustrating a coaxial arrangement of the conduits 208, 210, and 214. Similarly, the axial cross-section of FIG. 2 is indicated along the line 2-2 of FIG. 3. In the illustrated embodiment, each of the conduits 208, 210, and 214 has an annular wall in the radial cross-section. Furthermore, the conduits 208, 210, and 214 are co-axial or concentric with one another, thereby providing co-flows of the oxygen 204 and the fuel 101 along concentric flow paths. The third conduit 214 surrounds both the second and first conduits 210 and 208, while the second conduit 210 surrounds the first conduit 208. The interior 217 of the venturi section 216 is illustrated inside the first conduit 208. For example, the downstream portion 223 is shown diverging from the throat 219 to the first conduit 208. The geometry of the venturi section 216 is selected to control the flow through the first conduit 208. In addition, the spacing between the first and second conduits 208 and 210 and the second and third conduits 210 and 214 is selected to control the flow between the conduits 208, 210, and 214. In certain embodiments, flow control devices 216 (e.g., venturi sections or restriction orifices) may be disposed between the first and second conduits 208 and 210 and/or between the second and third conduits 210 and 214. Other arrangements of flows through the fuel injector 104, other than that illustrated in FIG. 3, are possible as well. For example, the fuel 101 may pass through the first conduit 208 and/or the third conduit 214. Similarly, the oxygen 204 may pass through the second conduit 210. In other words, the fuel injector 104 may be configured with any of the fluids described above, or any other fluids, passing through one or more of any of the conduits of the fuel injector 104. In other embodiments, the number of conduits in the fuel injector 104 may be fewer or greater (e.g., 2 to 10) than the number of conduits shown in FIG. 3.

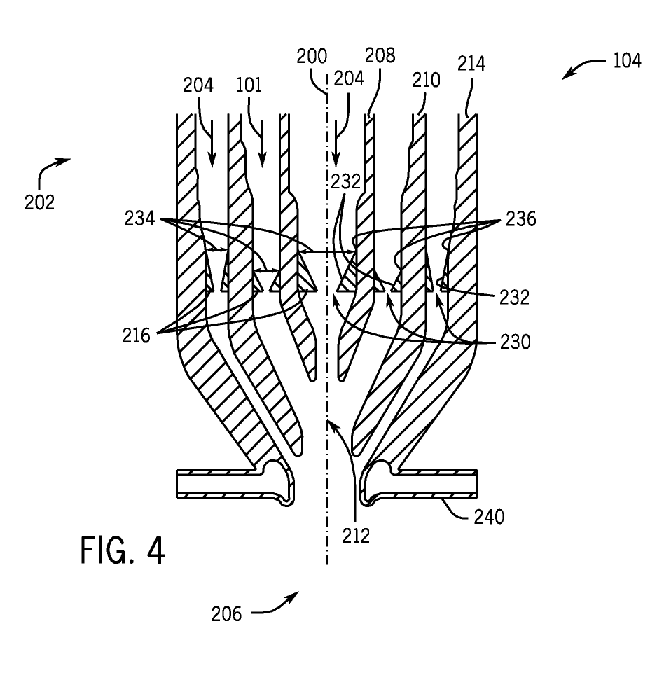

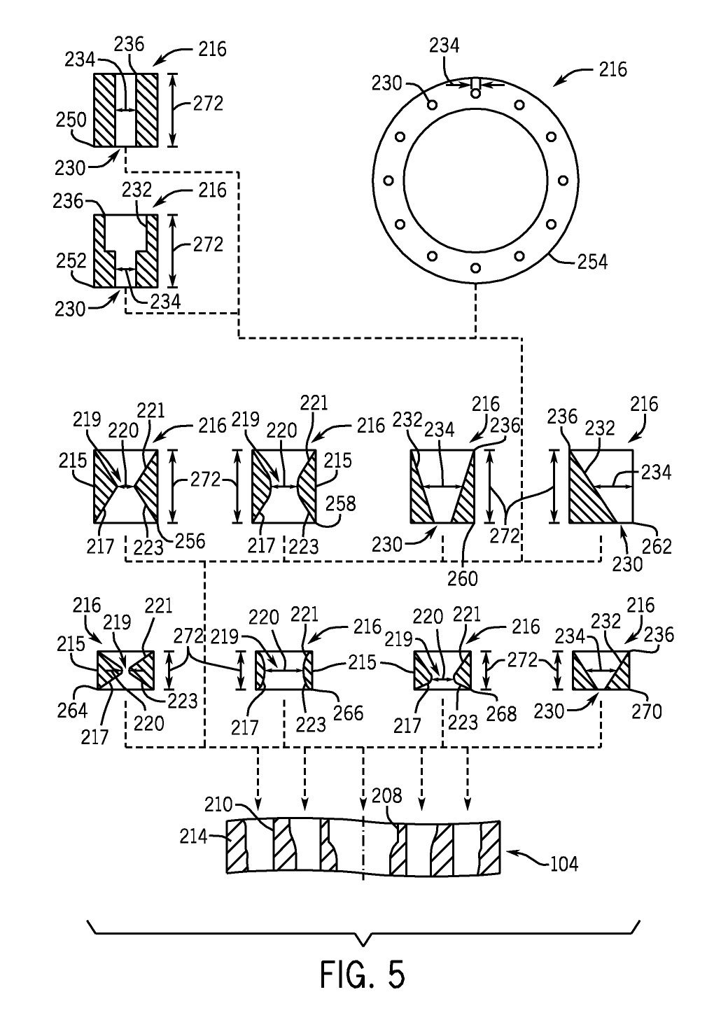

FIG. 4 is an axial cross-section of an embodiment of the fuel injector 104 with flow control devices 216 disposed in the first, second, and third conduits 208, 210, and 214. Although the illustrated embodiment includes a flow control device 216 in all three passages defined by the conduits 208, 210, and 214, other embodiments may include only one or two flow control devices 216. In the illustrated embodiment, the flow control devices 216 include a restriction opening, passage, orifice, or throat 230. The illustrated flow control devices 216 may function similarly to the venturi section described above to limit flow rates of fluids through conduits 208, 210, and 214 of the fuel injector 104. As illustrated, the flow control devices 216 include a converging passage 232 leading to the throat 230. For example, the converging passage 232 may be a conical passage or a curved annular passage leading to the throat 230. As shown in FIG. 4, a diameter 234 of the converging passage 232 gradually decreases from an upstream end or inlet 236 to the throat 230. In other embodiments, the flow control devices 216 may exclude the converging passage 232 and abruptly lead to the throat 230, e.g., a flat plate with an opening as the throat 230. In addition, the flow control device 216 of FIG. 4 excludes a downstream diverging portion (e.g., 223) in contrast to the flow control device 216 (e.g., venturi section) of FIG. 3. As illustrated, the flow control device 216 in the first conduit 208 has a conical converging passage 232 leading to a central throat 230 along the axis 200. The flow control device 216 between the first and second conduits 208 and 210 has an annular shape, and thus the converging passage 232 and the throat 230 have an annular shape around the axis 200. The flow control device 216 between the second and third passages 210 and 214 also has an annular shape, and thus the converging passage 232 and the throat 230 have an annular shape around the axis 200. In the illustrated embodiment, each flow control device 216 has a different geometry, e.g., slope or angle of the converging passage, length, diameter at the throat 230, and so forth. In addition, the flow control devices 216 may be removable and swapped with other flow control devices 216, such as the flow control devices 216 illustrated in FIG. 5.

In addition, certain embodiments may include a coolant chamber 240 disposed near the tip 206 of the fuel injector 104, as shown in FIG. 4. A coolant may be configured to flow through the coolant chamber 240 to help protect the tip 206 of the fuel injector 104 from the hot gases generated inside the gasifier 106. Other embodiments of the fuel injector 104 may include coolant passage along one or more of the conduits 208, 210, or 214. In some embodiments, the flow control devices 216 may include coolant passages to facilitate cooling.

FIG. 5 is an exploded schematic of various configurations of the flow control device 216, which may be removably coupled to one or more of the conduits 208, 210, or 214 of the fuel injector 104 of FIG. 4. As illustrated, the flow control devices 216 include a plurality of swappable flow control devices 250, 252, 254, 256, 258, 260, 262, 264, 266, 268, and 270, which differ in a variety of respects, such as having different ranges of flow control, different flow control structures, and/or different flow passage geometries. The flow control devices 250, 252, 256, 258, 260, 262, 264, 266, 268, and 270 are shown as axial cross-sections, whereas the flow control device 254 is shown as a top view. The flow control devices 216 may have a one-piece or multi-piece construction depending on the conduit location, e.g., central conduit 208 or surrounding annular conduits 210 or 214. For example, the flow control devices 216 may have a one-piece construction if installed in central conduit 208, and a two-piece construction if installed in the outer annular conduits 210 or 214.

For example, flow control devices 256, 258, 264, 266, and 268 may all be described as venturi sections, as the devices include upstream converging portions 221 and downstream diverging portions 223. The throat 219 of flow control device 256 has a generally sharp edge compared to the throats 219 of flow control devices 258, 264, 266, and 268, which are generally curved. In addition, the inner diameters 220 of the throats 219 may differ. For example, the inner diameter of the throat 219 of flow control device 264 is less than the inner diameter 220 of the throat 219 of flow control device 266. Moreover, the inner diameter 220 of flow control device 256 changes in a linear manner with a straight taper compared to the inner diameter 220 of flow control device 266, which changes in a non-linear manner with a curved taper. In addition, the upstream and downstream portions 221 and 223 of flow control devices 256, 258, 264, and 266 are generally symmetric relative to the throat 219, whereas the portions 221 and 223 of flow control device 268 are not symmetric relative to the throat 219. Further, heights 272 of flow control devices 256 and 258 are greater than the heights 272 of flow control devices 264, 266, and 268.

Flow control devices 252, 262, and 270 include converging passages 232, but exclude a downstream diverging portion (e.g., 223) and also differ from one another. For example, the converging passage 232 of flow control device 252 is stepped rather than tapered like the converging passages 232 of flow control devices 260, 262, and 270. In addition, the diameters 234 of the throats 230 may differ. For example, the diameter 234 of the throat 230 of flow control device 270 is less than the diameter 234 of the throat 230 of flow control device 252. Moreover, the diameter 234 of the inlet 236 of flow control device 252 is less than the diameter 234 of the conduit 208, 210, or 214 receiving the device 252. In contrast, the diameters 234 of the inlets 236 of flow control devices 260, 262, and 270 are approximately the same as the diameters 234 of the conduits in which the devices 260, 262, and 270 are disposed. Further, when disposed in an annular conduit 210 or 214, flow control devices 252, 260, and 270 include inner and outer annular components. In contrast, flow control device 262 only includes one annular component when disposed in an annual conduit.

Flow control devices 250 and 254 differ from the previously described flow control devices 252, 256, 258, 260, 262, 264, 266, 268, and 270. For example, flow control device 250 does not include a converging passage 232. Instead, the diameter 234 remains approximately the same throughout the throat 230 of flow control device 250. Thus, the throat 230 may be described as a restriction orifice or passage. However, each of the illustrated flow control devices 216 has a throat 230, which also may be described as a restriction orifice or passage. The difference between the flow control devices 216 relates to the upstream and downstream passages (if any), the dimensions, and so forth. Similar to the flow control device 250, the flow control device 254 includes a plurality of throats 230, spaced evenly or irregularly apart from one another. As illustrated, the flow control device 254 has an annular shape configured to mount within an annular passage, e.g., conduit 210 or 214. Furthermore, each of the openings in the flow control device 254 may act as a separate flow control device, which may be configured in a similar manner to any of the previously described flow control devices 250, 252, 256, 258, 260, 262, 264, 266, 268, and 270. The throats 230 of flow control device 254 may differ from one another. For example, the diameters 234 of the throats 230 may not all be the same. In addition, a variety of shapes may be used for the throats 230, such as, but not limited to, circles, ovals, triangles, squares, rectangles, and so forth. In fact, such shapes may be used for any of the previously described flow control devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gasification fuel injector, comprising:
a body having a tip portion;
a first conduit extending through the body toward the tip portion;
a second conduit extending through the body toward the tip portion; and
a flow control device disposed in the first conduit upstream of the tip portion, wherein the flow control device is configured to limit a first flow through the first conduit.

2. The system of claim 1, wherein the flow control device comprises a venturi section.

3. The system of claim 1, wherein the flow control device comprises a restriction orifice.

4. The system of claim 1, wherein the flow control device comprises a removable insert.

5. The system of claim 4, wherein the removable insert is selectively swappable with a plurality of removable inserts, wherein each insert of the plurality of removable inserts comprises a different range of flow control, a different flow control structure, or a different flow passage geometry.

6. The system of claim 1, wherein the first and second conduits are concentric with one another.

7. The system of claim 6, wherein the second conduit surrounds the first conduit.

8. The system of claim 1, wherein the flow control device controls a split of flow between the first conduit and the second conduit.

9. The system of claim 1, wherein the first conduit comprises a gas conduit configured to flow a gas.

10. The system of claim 9, wherein the gas comprises oxygen, carbon dioxide, air, nitrogen, steam, or a combination thereof.

11. The system of claim 1, wherein the first conduit comprises a fuel conduit configured to flow a fuel.

12. The system of claim 1, comprising a third conduit extending through the body toward the tip portion, wherein the first, second, and third conduits are concentric with one another.

13. The system of claim 1, comprising a gasifier having the gasification fuel injector.

14. A system, comprising:
a fuel injector, comprising:
a body having a tip portion;
a first conduit extending through the body toward the tip portion; and
a removable insert disposed in the first conduit, wherein the removable insert comprises a flow control feature to limit flow through the first conduit to a range.

15. The system of claim 14, wherein the fuel injector comprises a gasification fuel injector.

16. The system of claim 14, wherein the flow control feature comprises a venturi section.

17. The system of claim 14, wherein the flow control feature comprises a restriction orifice.

18. A system, comprising:
a fuel injector, comprising:
a first conduit configured to inject a first fluid;
a second conduit configured to inject a second fluid different from the first fluid, wherein the first and second conduits are coaxial with one another; and
a flow control device disposed in the first conduit, wherein the flow control device comprises a throat.

19. The system of claim 18, wherein the flow control device comprises a venturi section having the throat.

20. The system of claim 18, comprising a third conduit configured to inject a third fluid, wherein the first, second, and third conduits are coaxial with one another.
